(19) United States
(12) Patent Application Publication
(10) Pub. No.: US 2017/0229942 A1
(43) Pub. Date: Aug. 10, 2017

(54) ELECTRIC MACHINE WITH INTEGRATED THERMAL BUFFER AND DRIVE UNIT COMPRISING SAID ELECTRIC MACHINE

(71) Applicant: Schaeffler Technologies AG & Co. KG, Herzogenaurach (DE)

(72) Inventors: Martin BECK, Plauen (DE); Christian KUEHHIRT, Steinbach-Hallenberg (DE); Michael ASCHE, Schmalkalden (DE)

(21) Appl. No.: 15/518,560

(22) PCT Filed: Oct. 6, 2015
(86) PCT No.: PCT/DE2015/200468

§ 371 Date: Apr. 12, 2017

(30) Foreign Application Priority Data
Oct. 13, 2014 (DE) 10 2014 014 885.8
Oct. 21, 2014 (DE) 10 2014 221 303.7

(51) Int. Cl. H02K 9/19; H02K 5/20

(52) U.S. Cl. CPC H02K 9/19; H02K 5/20; H02K 9/193

(57) ABSTRACT

An electric machine (01), including a rotor (06), a stator (03), an electric winding (04) and a housing (02). The electric machine has an overall thermal resistance in relation to the surroundings which is dimensioned such that the continuous heat losses resulting from a continuous operating current being fed to the electric winding (04) is carried off to the surroundings so that at a predetermined ambient temperature a predetermined maximum winding temperature is not exceeded. The electric machine is characterized in that the housing (02) is filled with a dielectric liquid (11). The liquid has a heat capacity which is dimensioned such that it can absorb a peak load heat quantity which is given off by the electric winding (04), in excess to the continuous heat losses, when said winding is operated at a peak current during a peak load operating time.

The present invention relates to an electric machine, which initially includes a rotor and a stator as well as an electric winding in the conventional manner. The housing surrounds the rotor, the stator and the electric winding. It is possible that the housing, or parts thereof, is an integral part of the rotor. The electric machine may be configured as an electric motor or as a generator. By suitably selecting the electrical connection of the electric winding as well as its configuration within the electric machine, the latter may be constructed as a synchronous machine, an asynchronous machine or a reluctance machine. With regard to the mechanical construction of a machine of this type, a distinction may be made between an internal rotor and an external rotor depending on the application.

For the purpose of understanding the present invention, it is important that an electric machine of this type have an overall thermal resistance with respect to the surroundings. The overall thermal resistance may be influenced, for example, by structural measures, in particular by a suitable material selection and shaping of the housing. In a normal operating state, which is provided for continuous operation, the overall thermal resistance must be dimensioned in such a way that the heat losses resulting during the feeding of a continuous operating current to the electric winding are sufficiently quickly dissipated to the surroundings, so that, at a given ambient temperature, a predetermined maximum winding temperature at which neither the electric winding nor the entire electric machine experiences thermally induced damage, is not exceeded.

### BACKGROUND

In the related art, different options have become known, which suitably dissipate the heat losses occurring in the electric winding during the normal operating state of an electric machine. For example, the housing may be equipped with cooling plates or be integrated into a separate cooling circuit. It is likewise possible to provide cooling channels within the electric machine, through which a cooling medium flows to absorb the heat losses preferably close to the electric winding and to transport it to the outside. Active cooling systems of this type are structurally complex and make the electric machine and its operation significantly more expensive. Moreover, the weight of the electric machine increases thereby, which is a hindrance, in particular, for mobile applications.

Different applications exist for electric machines in which a relatively low continuous operating load is demanded, which consequently only permits low heat losses to occur. In such cases, an active cooling of the electric machine may be dispensed with, since due to the heat transfer between the individual components of the electric machine, the heat losses are predominantly transferred from the electric winding to the housing, where they are dissipated to the surroundings, in the simplest case through heat dissipation to the ambient air.

In certain application situations, peak loads are demanded of an electric machine of this type, which may be significantly higher than the dimensioned continuous operating load within a short period of time, and in particular a multiple of the continuous operating load.

The dimensioning of the electric winding of the electric machine is generally definitively determined by the heat losses to be dissipated if active cooling is dispensed with. To avoid thermal destruction of the electric winding, wire cross sections and insulation precautions must therefore be selected, which would permit a much higher operating current solely from an electrical point of view, i.e., which may electromagnetically generate a peak power which is significantly above the continuous operating load. Upon demanding a peak load, however, the heat losses also increase dramatically, so that peak loads of this type may be demanded only for a very short period of time, since a thermal destruction of the electric winding would otherwise result, for example if the insulation coating on the electric winding softens or even catches fire. To demand a higher operating power over a medium period of time, electric machines must therefore up to now be dimensioned to be much more powerful, or an active cooling must be additionally provided in the aforementioned way.

### SUMMARY OF THE INVENTION

It is an object of the present invention to provide an electric machine, which is configured under thermal aspects for a predetermined continuous operating load, dispenses with active cooling and nevertheless is able to provide a higher peak power which is significantly above the continuous operating load over a medium period of time, without the electric machine sustaining thermal damage. Another object of the present invention is to provide a drive unit, which is able to provide a much higher peak power above a continuous operating power, for a period of time of several minutes required in typical drive situations.

The electric machine according to the present invention is characterized in that the housing is filled with a dielectric liquid, which has a heat capacity which is dimensioned to absorb a peak load heat quantity, which is given off by the electric winding when the latter is operated at a peak current during a peak load operating time. The heat capacity of the dielectric liquid is preferably dimensioned in such a way that, during the peak load operating time, the heat quantity of the additional heat sources which are immanent in the electric machine is also absorbable, i.e. coming from, e.g., stator iron losses, rotor iron losses, bearing losses and magnet losses. The peak load operating time is preferably 1 to 15 minutes, particularly preferably 5 to 10 minutes.

One important advantage of the electric machine according to the present invention is thus that, in contrast to the prior art described above, the losses may be absorbed and buffered directly at their points of origin. The heat is transferred to the surrounding system (cooler components) by free and not by forced convection.

The dielectric liquid filled into the housing is used primarily to expand the thermal inertia of the entire electric machine, to homogenize the temperature distribution within the electric machine and, to a certain extent, to also act upon the moving parts of the electric machine in a mechanically damping way. As a function of the quantity of the filled dielectric liquid and the specific heat capacity of the liquid, the overall heat capacity of the electric machine is significantly increased compared to the unfilled state. In the peak load case, therefore, the heat quantity generated by the electric winding is temporarily absorbed by the dielectric liquid. The dielectric liquid is thus used primarily as a thermal buffer and not as a heat transport medium, since the dielectric liquid does not communicate with a cooling system outside the electric machine. Within the electric machine, the dielectric liquid naturally transports the resulting heat losses to the different structural components and spaces embedded into the dielectric liquid or through which the latter flows.

This dielectric liquid is preferably a highly thermoconductive oil, which has a high heat capacity, on the one hand, and does not permit an electric short circuit between different sections of the electric winding, on the other hand. The oil may be simultaneously used to lubricate the bearing units of the electric machine, whereby a separate lubrication system may be dispensed with. Different options for sealing rotation bearings are known to those skilled in the art, so that an escape of the oil from the electric machine is safely avoided even at the bearing points.

Most of the space, in particular nearly preferably all of the space remaining between the rotor and the stator in the housing is preferably filled with the oil used as the dielectric liquid. The rotation of the moving parts of the electric machine ensures that the oil is quickly distributed within the electric machine during operation. In one preferred specific embodiment, additional vane elements are mounted on the rotor, which further accelerate a mixing and distribution of the oil.

In one advantageous specific embodiment, the housing includes a filler neck, via which the dielectric liquid may be filled during the manufacturing process. After closing the filler neck, the housing as a whole is sealed liquid-tight, so that an escape of the dielectric liquid is impossible.

In a modified specific embodiment, the filler neck may also be designed in such a way that it may be opened and closed again by the user of the electric machine for the purpose of filling the dielectric liquid. In this way, electric machines manufactured as standard may be adapted to different applications by the user, in that the dielectric liquid used to increase the heat capacity is filled only when peak load states may arise which, without this additional heat capacity, would cause a thermal overload of the machine.

The present invention also provides a drive unit, including an electric motor and a drive element coupled to this electric motor, the electric motor being configured as the electric machine in the design described above.

Drive units of this type are suitable, in particular, for actuator tasks, in which a higher driving force is needed only for a relatively short period of time, for example only a few minutes, while the electric motor is either stopped during the remaining periods of time, or to which a much lower continuous load is applied. The electric motor is adapted to the primarily occurring continuous load in such a way that the arising heat losses may be passively dissipated to the surroundings without an additional cooling device.

For example, ball screw spindles, ball planetary spindles, hydraulic cylinders, cable winches or similar drive elements may be used as the drive element in a drive unit of this type. Therefore, the drive unit according to the present invention may be used, for example, for lifting or handling drives in work vehicles, e.g., for waste disposal or for loading and unloading loads. A drive unit according to the present invention may drive, for example, the lifting device on a waste disposal vehicle, the tail lift on a truck or the lifting crane on an arbitrary transport vehicle. Other typical applications are the extension of hydraulic stanchions on vehicles or the positioning of working units on construction machines. In general, the drive unit according to the present invention is particularly suitable for a combination with hydraulic drives, in which an increased load demand arises only for a short period of time. Due to the described increase in heat capacity of the electric machine, an increased power density may be provided, which is comparable to a hydraulic actuator.

The dielectric liquid filled into the housing of the electric machine absorbs the increased heat losses and dissipates these to the surroundings in a delayed manner via the housing at the end of the peak load state, without an active cooling system being required for this purpose. Due to the fast distribution of the heat losses within the electric machine, which is also achieved, the mechanical stresses are also reduced, which could otherwise occur and result in damage in the event of an uneven heat distribution within the electric machine.

### BRIEF DESCRIPTION OF THE DRAWING

Further advantages, details and refinements of the present invention result from the following description of one preferred specific embodiment with reference to the drawing.

The FIGURE shows a greatly simplified longitudinal sectional view of the principle structure of an electric machine, which is designed as an internal rotor motor.

### DETAILED DESCRIPTION

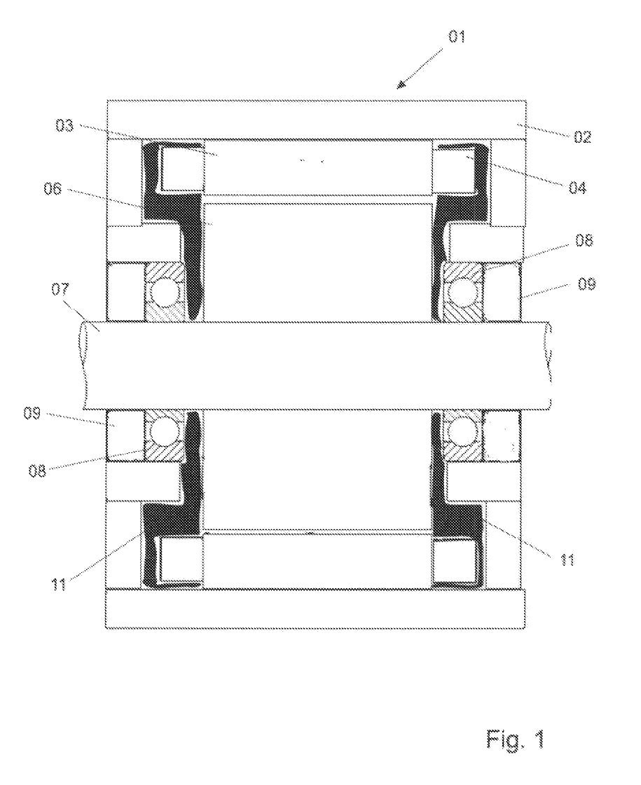

An electric motor 01 illustrated in FIG. 1 includes a housing 02, which is sealed liquid-tight. A stator 03, which carries an electric winding 04, is situated within housing 02. Electric winding 04 may include multiple coil units, which are electrically interconnected with each other, depending on the desired type of operation, and which are supplied with a driving current from an external control unit (not illustrated).

Electric motor 01 furthermore includes in this case an internal rotor 06, which is connected to a motor shaft 07. Motor shaft 07 is supported by rolling bearings 08, which are held in housing 02 and sealed via a bearing seal 09 for the purpose of preventing the escape of liquid from housing 02.

Electric winding 04 is dimensioned in such a way that the heat losses occurring during a continuous or normal operating state may be dissipated to housing 02 and, from there, to the surroundings without requiring an additional cooling system and without exceeding a maximum permissible winding temperature.

The cavities remaining between stator 03 and rotor 06 within housing 02 are filled with a dielectric liquid 11, which, in this specific embodiment, almost completely fills the cavities. In modified specific embodiments, the free space within housing 02 is filled to approximately 50% to 80% as a function of the required heat capacity provided by the dielectric liquid.

Those skilled in the art may easily determine the minimum quantity of dielectric liquid needed, in particular oil, based on the peak load heat quantity occurring in the peak load case. The difference between the heat quantity generated by the electric machine in the normal operating state and that dissipated to the surroundings by heat transfer must initially be absorbed by the dielectric liquid, which acts as a thermal buffer. In the simplest case, the required quantity for completely absorbing this peak load heat quantity may be calculated using the specific heat capacity of the dielectric liquid employed.

If a more precise dimensioning is desired, the passive heat dissipation may be taken into account, which also results in a transfer of the occurring heat losses in the peak load state. This is also dependent on the ambient temperature, which may be ascertained as needed with the aid of a temperature sensor. The resulting temperature gradient between the instantaneous operating temperature at housing 02 and the ambient temperature may be taken into account within a control unit for the purpose of generating a warning signal as needed or ending the peak load operating state when the electric winding is at risk of overheating. The control unit may also be configured in such a way that, after passing through a peak load state for a predefined period of time, only operation in the normal operating state is made possible, so that sufficient time is available to passively dissipate the additional heat quantity absorbed by the dielectric liquid to the surroundings. A peak load state may be permitted again only when this time has elapsed, or upon reaching a normal operating temperature of the dielectric liquid.

Those skilled in the art will easily recognize that the present invention may also be used in modified specific embodiments of electric machines. In particular, it may be advantageous to structurally increase in a targeted manner the cavity within the housing to be filled with the dielectric liquid to be able to provide a greater heat capacity via the liquid to be filled.

Temperature gradient profiles may be stored in the aforementioned control unit to be able to represent typical operating states and thus influence the control of the electric machine.

### LIST OF REFERENCE NUMERALS

01—electric motor
02—housing
03—stator
04—electric winding
06—rotor
07—motor shaft
08—rolling bearing
09—bearing seal
11—dielectric liquid/oil

What is claimed is:

1-10. (canceled)

11. An electric machine comprising:
a rotor;
a stator;
an electric winding; and
a housing, the electric machine having an overall thermal resistance with respect to surroundings, the overall thermal resistance being dimensioned such that continuous heat losses resulting during the feeding of a continuous operating current to the electric winding are dissipated to the surroundings at a predetermined ambient temperature and a predetermined maximum winding temperature, the housing being filled with a dielectric liquid having a heat capacity dimensioned to absorb a peak load heat quantity given off by the electric winding beyond the continuous heat losses when the electric winding is operated at a peak current during a peak load operating time.

12. The electric machine as recited in claim 11 wherein the dielectric liquid is an oil or an oil-containing mixture, and the housing is sealed liquid-tight.

13. The electric machine as recited in claim 11 wherein the heat capacity of the dielectric liquid is dimensioned to absorb a peak load heat quantity, the peak load heat quantity including a heat quantity given off by the electric winding beyond the continuous heat losses as well as the heat quantity, given off by other heat sources, which are immanent in the electric machine.

14. The electric machine as recited in claim 11 wherein the housing is filled with a quantity of the dielectric liquid filling 50% to 100% of free space in the housing.

15. The electric machine as recited in claim 11 wherein vane elements are mounted on the rotor, the vane elements configured for engaging with the dielectric liquid and inducing a mixing and distribution of the dielectric liquid during rotation.

16. The electric machine as recited in claim 11 wherein the housing includes a filler neck via which the dielectric liquid is fillable.

17. A drive unit including an electric motor and a drive element coupled thereto, the electric motor being the electric machine as recited in claim 11.

18. The drive unit as recited in claim 17 further comprising a control unit feeding a drive current to the electric motor in a normal operating state, the drive current not exceeding the continuous operating current of the electric machine, the control unit feeding a peak current to the electric motor in a peak load state for a peak load period of time not greater than the time required to generate the peak load heat quantity.

19. The drive unit as recited in claim 18 further comprising a temperature sensor, with the aid of which the control unit measures the instantaneous ambient temperature, the instantaneous ambient temperature being taken into account in the determination of the peak load heat quantity.

20. The drive unit as recited in claim 17 wherein the drive element is selected from the following group:
a ball screw spindle,
a ball planetary spindle,
a hydraulic cylinder, and
a cable winch.
